(19) United States
(12) Patent Application Publication
(10) Pub. No.: US 2025/0074526 A1
(43) Pub. Date: Mar. 6, 2025

(54) VARIABLE SPOILER WING OF MOTORCYCLE

(71) Applicant: KWANG YANG MOTOR CO., LTD., KAOHSIUNG CITY (TW)

(72) Inventor: HAO-YU WU, KAOHSIUNG CITY (TW)

(21) Appl. No.: 18/761,331

(22) Filed: Jul. 2, 2024

(30) Foreign Application Priority Data
Sep. 1, 2023 (TW) 112133325

(51) Int. Cl. B62J 17/00; B62J 6/05; B62J 45/412; B62J 50/22

(52) U.S. Cl. CPC B62J 17/00; B62J 6/05; B62J 45/412; B62J 50/22

(57) ABSTRACT

A variable spoiler wing of a motorcycle is provided. The motorcycle includes a plurality of spoiler wings; an electronic control unit controlling operation of a power unit; an inertial measurement unit electrically connected with the electronic control unit; a throttle position sensor electrically connected with the electronic control unit; and a wheel speed detector electrically connected with the electronic control unit. The plurality of spoiler wings are controlled by an operation controller for operation. The operation controller is in information connection with one of the electronic control unit, the inertial measurement unit, the throttle position sensor, and the wheel speed detector and receives one or multiple messages from the inertial measurement unit, the throttle position sensor, the wheel speed detector, or the electronic control unit to have the spoiler wings vary a pitch angle to match a traveling condition of the motorcycle.

### BACKGROUND OF THE INVENTION

### (a) Technical Field of the Invention

The present invention relates to a variable spoiler wing of a motorcycle, and more particularly to a variable spoiler wing of a motorcycle that enhances operation controllability of traveling of the motorcycle.

### (b) Description of the Prior Art

As shown in FIG. 1, a motorcycle 1, when traveling at a relatively high speed, can be readily carried by an upward push force of airflows to cause a steering mechanism 11 of the motorcycle 1 to lift upward. This is referred to as a posture of wheelie of the vehicle head (front wheelie), which causes lowering of the frictional force generated by the front wheel of the motorcycle 1 to eventually lose the capability of traction. To alleviate the deficiency of upward lifting of the steering mechanism 11 of the motorcycle 1 during high speed traveling, manufacturers arrange spoiler wings 12, which are invariable, at two sides of a front of the vehicle body of the motorcycle 1 for effects of guiding airflow and stabilizing the steering mechanism 11. By means of the spoiler wings 12, when the motorcycle 1 is traveling at a high speed, external airflows relative to the traveling speed of the motorcycle 1 provide the spoiler wings 12 with a pressing force for downward pressing to thereby enhance the operation controllability of traveling of the motorcycle 1.

Although arranging the spoiler wings 12 that have the effect of guiding airflows at two sides of the vehicle body at locations adjacent to the steering mechanism 11 can stabilize the steering mechanism 11, the spoiler wings 12 are arranged as being fixed and invariable, and may cause, for the motorcycle 1 traveling at a low speed, an increase of wind resistance during the low speed traveling of the motorcycle 1, thereby imposing severe limiting to acceleration and extreme speed of the motorcycle 1.

Thus, it is a challenge of the vehicle manufacturers to provide a variable spoiler wing of a motorcycle that enhances operation controllability of traveling of the motorcycle and reduces wind resistance during traveling of the motorcycle.

### SUMMARY OF THE INVENTION

The primary objective of the present invention is to provide a variable spoiler wing of a motorcycle, which alleviates the deficiency of an existing invariable spoiler wing that is incapable of matching a traveling condition.

For such an objective, the present invention provides a variable spoiler wing of a motorcycle, wherein the motorcycle at least comprises a vehicle frame unit, the vehicle frame unit at least comprising a steering mechanism, the steering mechanism being provided with a dashboard device for displaying traveling data; a power unit, which is arranged on the vehicle frame unit; an electronic control unit, which is operable to control operation of the power unit; an inertial measurement unit, which is arranged on the vehicle frame unit and is electrically connected with the electronic control unit; a throttle position sensor, which is arranged on the vehicle frame unit and is electrically connected with the electronic control unit; a wheel speed detector, which is arranged on the vehicle frame unit and is electrically connected with the electronic control unit; a plurality of spoiler wings, the plurality of spoiler wings being operable as being controllable by an operation controller, the operation controller being in information connection with one of the electronic control unit, the inertial measurement unit, the throttle position sensor, and the wheel speed detector and receiving one or multiple messages from the inertial measurement unit, the throttle position sensor, the wheel speed detector, or the electronic control unit to have the spoiler wings varying a pitch angle to match with a traveling condition of the motorcycle.

The efficacy achieved in some embodiments of the present invention is that the operation controllability of traveling of a motorcycle can be enhanced.

### BRIEF DESCRIPTION OF THE DRAWINGS

FIG. 1 is a schematic view showing a known fixed spoiler wing of a motorcycle.

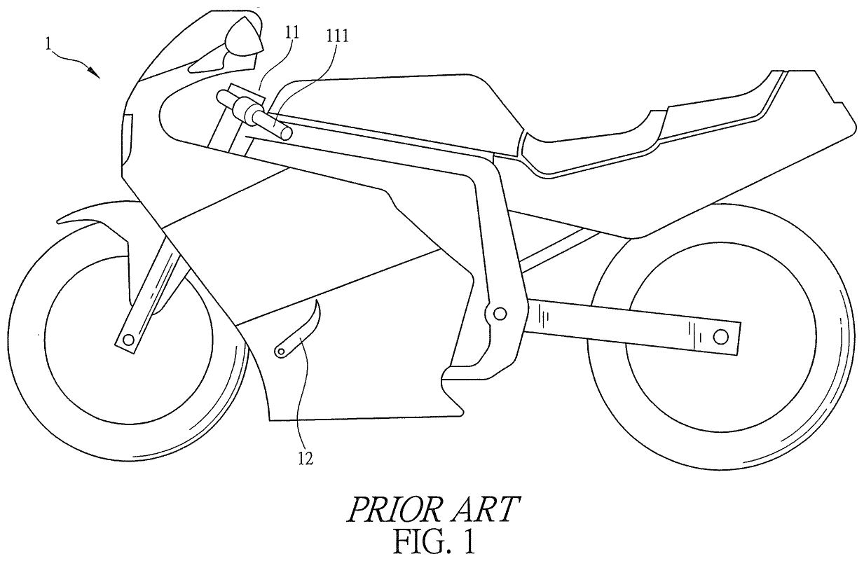

FIG. 2 is a side elevational view showing a motorcycle according to the present invention.

FIG. 3 is a perspective view showing the motorcycle of the present invention equipped with variable spoiler wings.

FIG. 4 is a schematic view showing installation of the spoiler wings according to the present invention.

FIG. 5 is another embodiment of the spoiler wings according to the present invention.

FIG. 6 is a flow chart of a spoiler wing control system of the present invention.

FIG. 7 is a schematic view illustrating an operation of the spoiler wings according to the present invention that causes a downward movement with a largest pressing force.

FIG. 8 is a schematic view illustrating an operation of the spoiler wings according to the present invention that causes a downward movement with a relatively small pressing force.

FIG. 9 is a schematic view illustrating an operation of the spoiler wings according to the present invention that causes a downward movement with a smallest pressing force.

FIG. 10 is a schematic view illustrating operation of the present invention after setting of a wheelie target value.

### DETAILED DESCRIPTION OF THE PREFERRED EMBODIMENTS

For better understanding of the structure of the present invention and the efficacy achievable thereby, a description will be provided in the following with reference to the attached drawings.

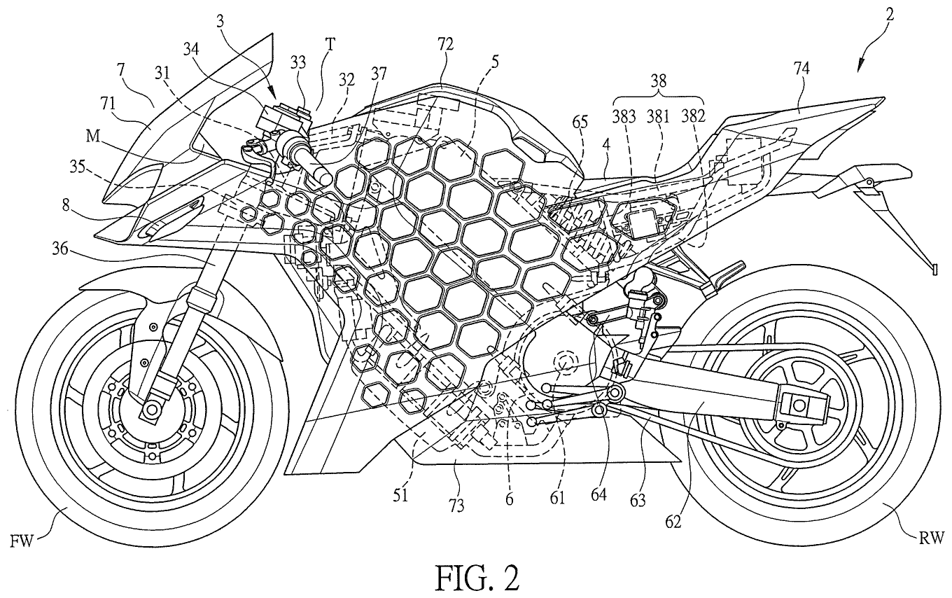

Firstly, referring to FIG. 2, it is noted first that in the present invention, a motorcycle 2 is illustrated by taking a straddle style electric motorcycle as an example. The motorcycle 2 at least comprises a vehicle frame unit 3, a seat cushion 4 arranged on the vehicle frame unit 3, a battery box body 5 arranged on the vehicle frame unit 3 and located at a front lower side of the seat cushion 4, a power unit 6 arranged on the battery box body 5, and a vehicle body cover 7 covering an outer periphery of the vehicle frame unit 2.

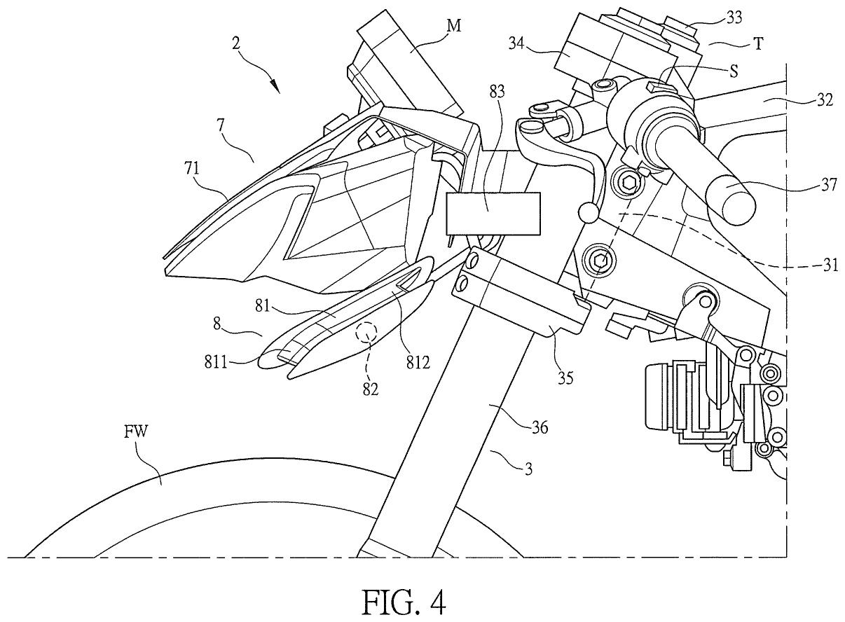

As shown in FIGS. 2 and 4, the vehicle frame unit 3 is provided, on a front thereof, with a head tube portion 31. The head tube portion 31 is provided, toward a vehicle body rear side, with a head tube support frame 32. The head tube portion 31 is provided, penetrating therethrough, with a steering column 33. The steering column 33 is provided, connected at a top thereof, with an upper coupling plate 34. The steering column 33 is provided, at a lower side thereof, a lower coupling plate 35. The upper coupling plate 34 and the lower coupling plate 35 are provided with a front fork unit 36 penetrating therethrough. The front fork unit 36 is provided, rotatably connected to a lower side thereof, with a front wheel FW. The front fork unit 36 is provided, closely adjacent to a lower side of the upper coupling plate 34, with steering handlebars 37 arranged pairwise as a left one and a right one, so that operation of the steering handlebars 37 makes the front fork unit 36, taking the steering column 33 as a rotation center, driving the front wheel FW to rotate. A wheel speed detector (not shown in the drawings) is mounted beside the front wheel FW, so that the wheel speed detector is operable to provide traveling speed data of the motorcycle 2. The steering column 33 and the steering handlebars 37 jointly form a steering mechanism T.

As shown in FIG. 2, the head tube support frame 32 is provided, fastened thereto at a side toward the vehicle body rear side, with a battery box body 5 in which a battery that supplies electrical power to a motor is received. Specifically, the battery box body 5 is arranged, by means of fastening, on the head tube support frame 32 in a manner of being inclined toward the vehicle body rear side. The battery box body 5 is provided, connected thereto at a side further toward the vehicle body rear side, a secondary vehicle frame 38, meaning the secondary vehicle frame 38 is fastened to a rear side surface of the battery box body 5 facing the vehicle body. The vehicle frame unit 3 is made up of the head tube portion 31, the head tube support frame 32, the battery box body 5, and the secondary vehicle frame 38, and in other words, the battery box body 5 is also a part that makes up the entirety of the vehicle frame unit 3. The secondary vehicle frame 38 comprises upper frame portions 381 arranged pairwise as a left one and a right one located at an upper side and lower frame portions 382 arranged pairwise as a left one and a right one located at a lower side, and a connecting frame portion 383 connecting between the upper frame portions 381 and the lower frame portions 382. The seat cushion 4 is arranged on the secondary vehicle frame 38.

As shown in FIG. 2, arranged at one side of the battery box body 5 that faces toward a front lower side of the vehicle body is a controller unit 51; and arranged at one side of the battery box body 5 that faces toward a rear lower side of the vehicle body is a power unit 6, and in the present invention, the power unit 6 is implemented as an electrical motor, and the controller unit 51 is operable to control the power unit 6. A rear swingarm 62 is arranged, in a rotatable manner, outside a power output axle 61 of the power unit 6, and a rear wheel RW is rotatably arranged at a rear side of the rear swingarm 62. The power output axle 61 of the power unit 6 drives, by means of a driving member 63, the rear wheel RW to rotate, so as to cause the electric motorcycle 2 to travel. The driving member 63 can be implemented with a belt or a chain. A coupling bracket 64, which is oscillatory, is arranged between the power unit 6 and the rear swingarm 62. A rear shock absorber 65 is rotatably arranged on the coupling bracket 64, and an opposite end of the rear shock absorber 65 is connected to the secondary vehicle frame 38 or the battery box body 5.

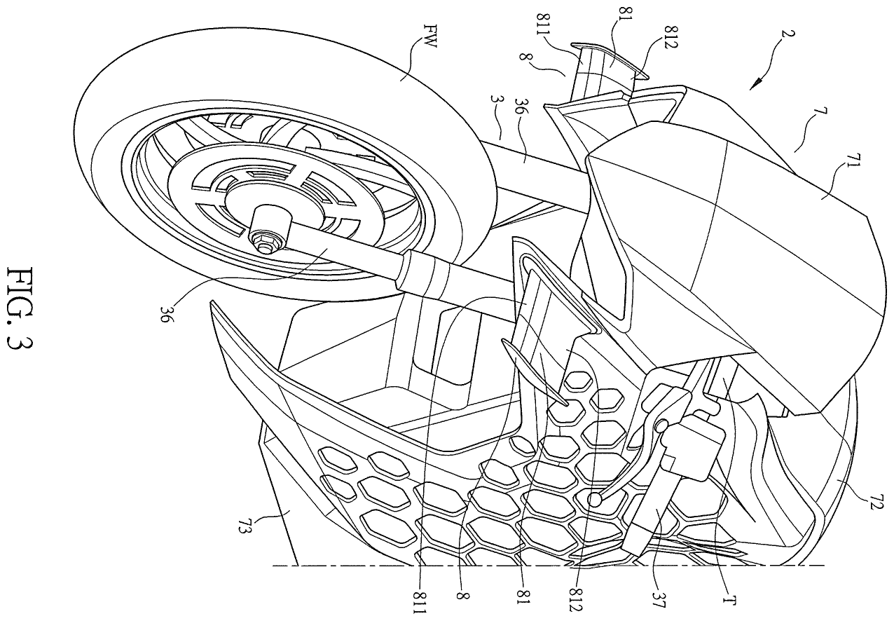

As shown in FIGS. 2 and 3, the vehicle body cover 7 comprises a vehicle head cover 71 that covers a front end of the vehicle body, an upper vehicle body cover 72 set on and covering an upper side of the vehicle body at a front side of the seat cushion 4, side vehicle body covers 73 set on and covering two opposite sides of the vehicle body, and a rear vehicle body cover 74 set on and covering a rear side of the vehicle body and located rearwardly of the seat cushion 4.

As shown in FIG. 2, to enhance controllability and safety of operation, the motorcycle 2 is installed with an inertial measurement unit (IMU) arranged on the secondary vehicle frame 38, an electronic control unit (ECU) arranged in the proximity of the power unit 6 to control vehicle operation, and a sensor arranged on the steering mechanism T (the steering handlebars 37) to detect an opening position of the steering handlebars 37, wherein in the present invention, a throttle position sensor (TPS) is taken as an example for illustration, and in case of implementation as an internal combustion engine motorcycle, the throttle position sensor (TPS) is a throttle position sensor. The inertial measurement unit is operable to detect data with respect to inclination angle and angular momentum of the motorcycle 2 in passing through a curve or in traveling. The electronic control unit (ECU) is operable to control operation of the entirety of the motorcycle 2. The throttle position sensor (TPS) is operable to control the power unit 6, and enables the power unit 6 to output a power matching traveling requirement of the operator.

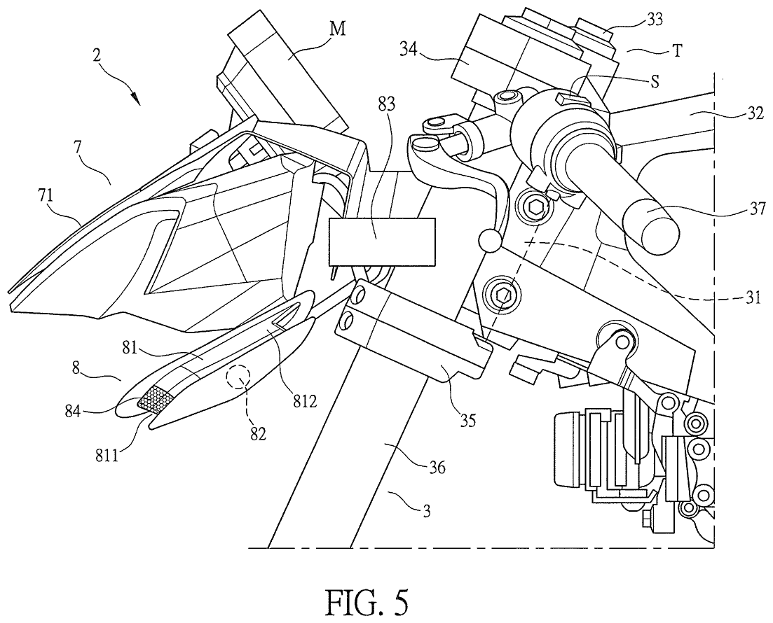

As shown in FIGS. 2, 3, 4, and 5, the motorcycle 2 is installed with spoiler wings 8 respectively on two sides of the vehicle head cover 71 and adjacent to the steering mechanism T. The spoiler wings 8 each comprise a wing body 81, a connection rod 82 connected to the wing body 81, and an operation controller 83 connected to the connection rod 82 and operable to cause the connection rod 82 to rotate. The wing body 81 comprises a front end portion 811 and a rear end portion 812. The front end portion 811 may be further provided with a direction indicator light 84 that indicates a traveling direction or a position light that indicates positioning of the motorcycle 2 to mount thereon, and in the present invention, mounting of the direction indicator light 84 is taken as an illustrative example. The motorcycle 2 comprises a spoiler wing control system A. The spoiler wing control system A controls the operation of the operation controller 83. The spoiler wing control system A can be arranged as a separate part, or one built in the operation controller 83 or built in the electronic control unit (ECU). In implementation, the spoiler wing control system A and the operation controller 83 are both built in the electronic control unit (ECU). The spoiler wing control system A is in electrical signal connection with the inertial measurement unit (IMU), the electronic control unit (ECU), a wheel speed detector, and the throttle position sensor (TPS), so that the spoiler wing control system A may receive from one or multiple ones of the inertial measurement unit (IMU), the electronic control unit (ECU), the wheel speed detector, and the throttle position sensor (TPS) to make the operation controller 83 operating, so that the operation controller 83 may have the connection rod 82 rotating to synchronously drive the wing body 81 to rotate.

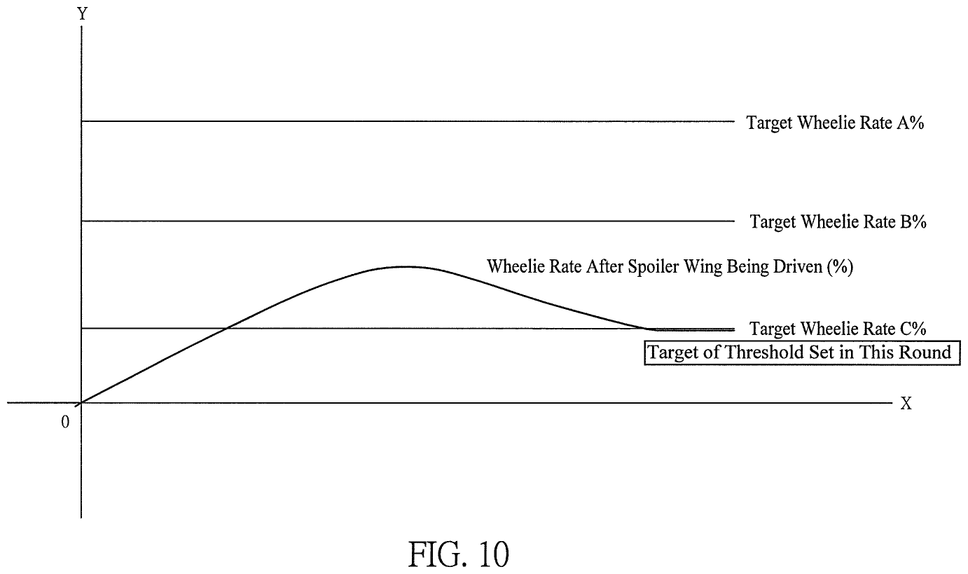

As shown in FIGS. 4, 5, 6, and 10, a specific way for the operation controller 83 to receive one or multiple signal parameters from the inertial measurement unit (IMU), the electronic control unit (ECU), the wheel speed detector, and the throttle position sensor (TPS) to cause operation of the operation controller 83 is as follows. The operation controller 83 may comprise a step motor, and the spoiler wing control system A is provided with an activation switch S, wherein the activation switch S can be arranged on the steering handlebars 37 or arranged on a dashboard device M that displays traveling data. When the operator activates, through pressing, the activation switch S, the spoiler wing control system A enters a step of “system starting up” A1 for a starting up operation. The spoiler wing control system A, after starting up, enters a selection step of “mode selection” A2, with which the operator may select to use a control knob (not shown in the drawings) arranged on the dashboard device M to cause operation of the operation controller 83 so as to adjust a pitch angle of the spoiler wings 8. In case that the operator does not select to use the control knob (not shown in the drawings) on the dashboard device M to cause the operation of the operation controller 83, the spoiler wing control system A subsequently enters a step of “anti-wheelie function mode” A3, wherein, at this moment, the operator may use the control knob arranged on the dashboard device M, or by means of pre-setting made in the electronic control unit (ECU), to set up “spoiler wing intervening threshold setting” A4 of the spoiler wing control system A. For example, as shown in FIG. 10, in which the X-axis is time axis, and Y-axis indicates wheelie rate, where the wheelie rate is defined as follows: variation rate of lifting/lowering of the vehicle head, wherein a positive value is assigned for the vehicle head raising upwards, and a negative value is assigned for the vehicle head lowering down, when the spoiler wing control system A enters the step of “anti-wheelie function mode” A3, the operator may make setting among three anti-wheelie function modes, which are low-level intervention, middle-level intervention, and high-level intervention, and the spoiler wing control system A sets up, respectively corresponding thereto, three intervention thresholds, which are respectively a target wheelie rate A %, a target wheelie rate B %, and a target wheelie rate C %. After the setting performed in the step of “spoiler wing intervening threshold setting” A4 has been completed, during traveling of the motorcycle 2, the spoiler wing control system A enters a step of “operator's intention detection” A5, which is that the spoiler wing control system A collects and combines the traveling data of the electronic control unit (ECU), including implementation of a step of “throttle position detection” A6, a step of “vehicle posture detection” A7, and a step of “wheel speed detection” A8 to acquire the traveling data, wherein in the step of “throttle position detection” A6, the spoiler wing control system A subsequently collects message from the throttle position sensor (TPS), and in the step of “vehicle posture detection” A7, the spoiler wing control system A subsequently collects message from the inertial measurement unit (IMU), and in the step of “wheel speed detection” A8, the spoiler wing control system A subsequently collects the wheel speed data, where the wheel speed data may come from the wheel speed detector. It is particularly noted that in the present invention, no specific sequence is assigned for the spoiler wing control system A to implement the step of “throttle position detection” A6, the step of “vehicle posture detection” A7, and the step of “wheel speed detection” A8, and the above is provided an illustrative example for understanding thereof.

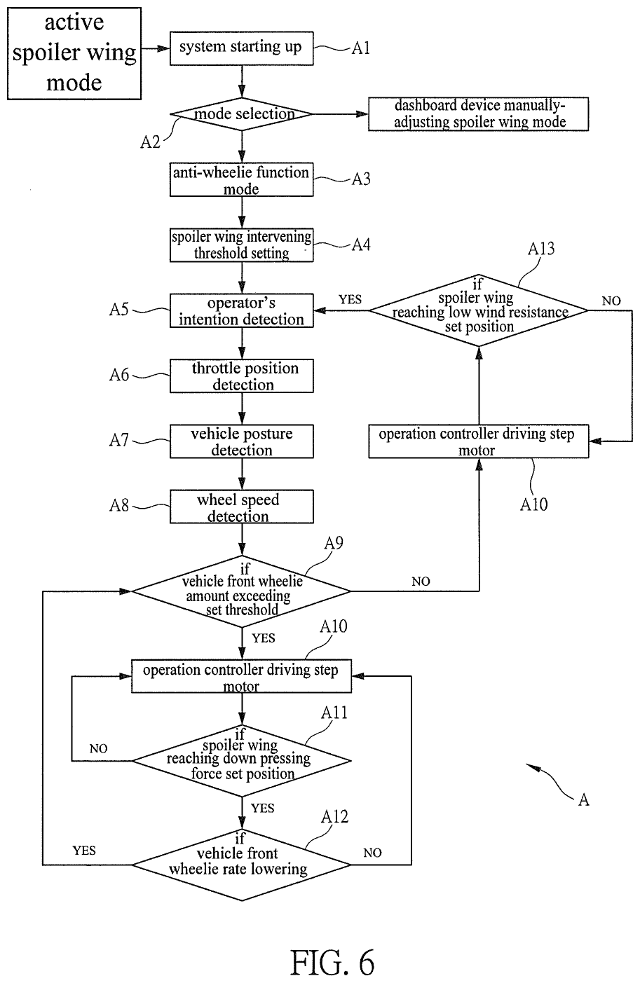

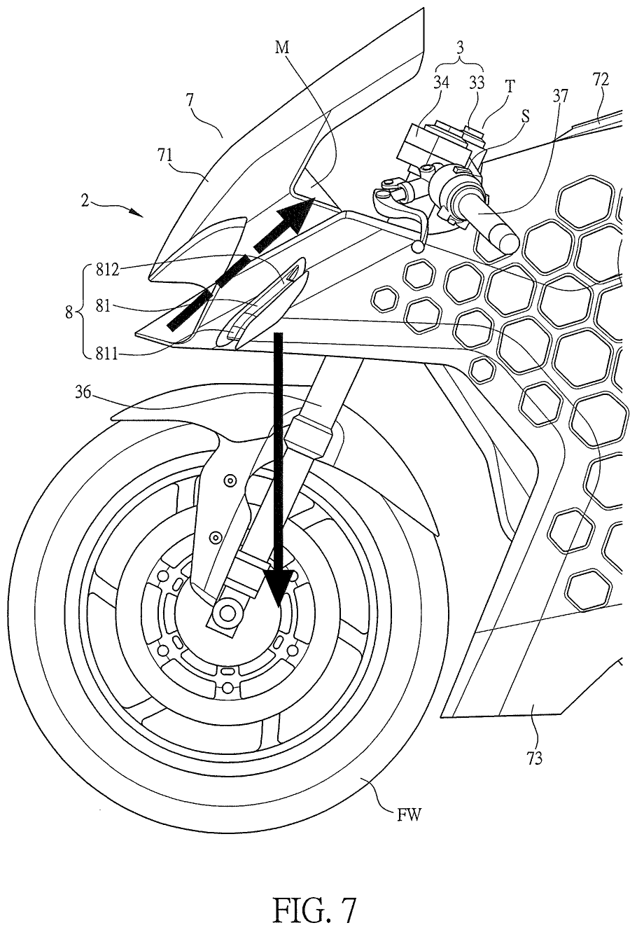

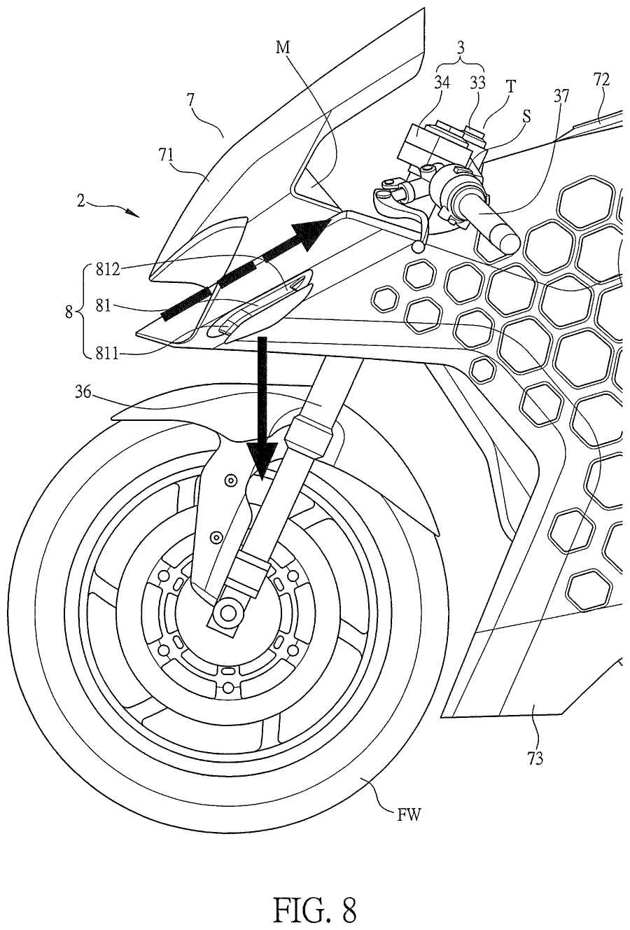

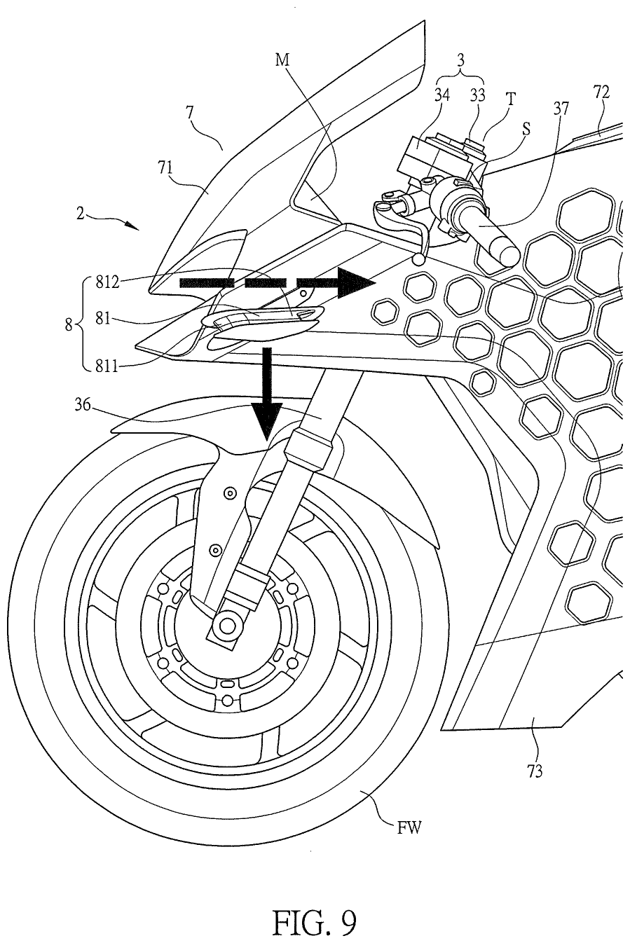

As shown in FIGS. 6, 7, 8, and 9, following the above, when the spoiler wing control system A acquires messages with respect of “operator's intention detection” A5, “throttle position detection” A6, “vehicle posture detection” A7, and “wheel speed detection” A8, the spoiler wing control system A then enters a discrimination step of “if vehicle front wheelie amount exceeding set threshold” A9, meaning based on a combination of the messages of the step of “throttle position detection” A6, the step of “vehicle posture detection” A7, and the step of “wheel speed detection” A8, in a condition where the spoiler wings 8 have not been driven, a predicted wheelie rate for vehicle operation can be calculated, and discrimination is made based on the target wheelie rate of the step of “spoiler wing intervening threshold setting” A4 corresponding to the predicted wheelie rate. In case that a result of discrimination made in “if vehicle front wheelie amount exceeding set threshold” A9 is “yes”, the spoiler wing control system A enters a step of “operation controller driving step motor” A10, and the step of “operation controller driving step motor” A10 makes the step motor activated to drive the spoiler wings 8 to rotate for varying a dive angle. After the spoiler wings 8 rotate to vary the dive angle, the spoiler wing control system A then enters a discrimination step of “if spoiler wing reaching down pressing force set position” A11, wherein the spoiler wing control system A discriminates if the position of the spoiler wings 8 after the rotation reaches a set position. In case that a result of discrimination made in “if spoiler wing reaching down pressing force set position” A11 is “yes”, the spoiler wing control system A finally enters a discrimination step of “if vehicle front wheelie rate lowering” A12, wherein after the intervention of the spoiler wings 8, the spoiler wing control system A discriminates if the wheelie rate of the front wheel lowers down; and in case that the result of discrimination of “if spoiler wing reaching down pressing force set position” A11 is “no”, the spoiler wing control system A returns back to the step of “operation controller driving step motor” A10. In case that a result of discrimination of “if vehicle front wheelie rate lowering” A12 is “yes”, the spoiler wing control system A returns back to the discrimination step of “if vehicle front wheelie amount exceeding set threshold” A9; and in case that the result of discrimination of “if vehicle front wheelie rate lowering” A12 is “no”, the spoiler wing control system A returns back to the step of “operation controller driving step motor” A10. In an illustrative example, a high-level intervention is set up in a current round of the step of “the anti-wheelie function mode” A3; the spoiler wing control system A sets, in the step of “spoiler wing intervening threshold setting” A4, a target threshold to be the target wheelie rate C % to correspond to the setting of the high-level intervention, and collects the traveling data in the step of “operator's intention detection” A5, the step of “throttle position detection” A6, the step of “vehicle posture detection” A7, and the step of “wheel speed detection” A8 and calculates a predicted wheelie rate for starting or traveling of the vehicle, and makes discrimination to determine, in the step of “if vehicle front wheelie amount exceeding set threshold” A9, if it exceeds the threshold value (for example the target wheelie rate C %), and in case that it exceeds the threshold value, the spoiler wing control system A enters the step of “operation controller driving step motor” A10 to have the operation controller 83 drive the step motor to rotate the spoiler wings 8, and then, in the step of “if spoiler wing reaching down pressing force set position” A11, the spoiler wing control system A discriminates if the spoiler wings 8 reach a set position, and if they reach the set position, further discrimination is made whether the wheelie rate of the front wheel FW of the motorcycle 2 lowers down or not, meaning in “if vehicle front wheelie rate lowering” A12, if the wheelie rate of the front wheel FW does not reach the target wheelie rate C %, then the operation controller 83 is caused, again, to drive the step motor to rotate the spoiler wings 8, to have the wheelie rate of the front wheel FW, after the spoiler wings 8 being driven, approaching the target wheelie rate C %. As noted above, the target wheelie rate can alternatively be set to A % or B %, so that the wheelie rate of the front wheel FW, after the spoiler wings 8 being so driven, is made approaching the target wheelie rate A % or B % to have the position of the spoiler wings 8 matching the traveling condition of the motorcycle 2 to thereby enhance the operation controllability of the motorcycle 2. It is particularly noted that the spoiler wing control system A does not operate when the motorcycle 2 is passing a bend in order to prevent a down pressing force to cause falling of the vehicle to thereby ensure traveling safety of the motorcycle 2.

As shown in FIGS. 6, 7, 8, and 9, continuously following the above, in case that the result of discrimination of “if vehicle front wheelie amount exceeding set threshold” A9 is “no”, the spoiler wing control system A then enters the step of “operation controller driving step motor” A10, meaning the spoiler wing control system A makes the operation controller 83 drive the step motor to return back the low wind resistance position for the spoiler wings 8 for traveling of the motorcycle 2, and then entering a discrimination step of “if spoiler wing reaching low wind resistance set position” A13. In case that a result of discrimination of “if spoiler wing reaching low wind resistance set position” A13 is “yes”, the spoiler wing control system A returns back to the step of “operator's intention detection” A5 to then carry out operations sequentially; and in case that the result of discrimination of “if spoiler wing reaching low wind resistance set position” A13 is “no”, the spoiler wing control system A returns to the step of “operation controller driving step motor” A10. As such, when the motorcycle 2 abruptly accelerates, the pitch angle of the spoiler wings 8 is adjusted to increase the down pressing force in order to suppress wheelie of the front wheel FW; when the motorcycle 2 abruptly decreases, the pitch angle of the spoiler wings 8 is adjusted to increase the wind resistance, in order to assist deceleration of the motorcycle 2; during regular riding, the pitch angle of the spoiler wings 8 is adjusted to reduce the wind resistance, in order to save consumption of fuel or consumption of electrical power; at an extreme speed of the motorcycle 2, the pitch angle of the spoiler wings 8 is adjusted to reduce the wind resistance, in order to heighten an upper limit of the extreme speed for the motorcycle 2 to thereby enhance the operation controllability of traveling of the motorcycle 2.

The primary efficacy of the present invention is that a motorcycle 2 at least comprises a vehicle frame unit 3, the vehicle frame unit 3 at least comprising a steering handlebar 37 of a steering mechanism T, the steering mechanism T being provided with a dashboard device M for displaying traveling data; the vehicle frame unit 3 is provided with a power unit 6; the vehicle frame unit 3 is covered, on an outside thereof, with a vehicle body cover 7; the motorcycle 2 is provided, for detecting a traveling condition, with an inertial measurement unit, a throttle position sensor, and an electronic control unit that controls operation of the power unit 6; the motorcycle is provided with a spoiler wing 8, the spoiler wing 8 being operable as being controlled by the operation controller 83, the operation controller being in information connection with the inertial measurement unit, the throttle position sensor, a wheel speed detector, and the electronic control unit, and being operable to receive one or multiple messages from the inertial measurement unit, the throttle position sensor, the wheel speed detector, or the electronic control unit to have the spoiler wing 8 varying a pitch angle to match the traveling condition of the motorcycle 2, so as to adjust the pitch angle of the spoiler wing 8 at an extreme speed of the motorcycle 2 to reduce a wind resistance to thereby heighten an upper limit for the extreme speed of the motorcycle 2, and as such, operation controllability of traveling of the motorcycle 2 can be enhanced.

1. A variable spoiler wing of a motorcycle, wherein the motorcycle at least comprises a vehicle frame unit, the vehicle frame unit at least comprising a steering mechanism, the steering mechanism being provided with a dashboard device for displaying traveling data; a power unit, which is arranged on the vehicle frame unit; an electronic control unit, which is operable to control operation of the power unit; an inertial measurement unit, which is arranged on the vehicle frame unit and is electrically connected with the electronic control unit; a throttle position sensor, which is arranged on the vehicle frame unit and is electrically connected with the electronic control unit; a wheel speed detector, which is arranged on the vehicle frame unit and is electrically connected with the electronic control unit; a plurality of spoiler wings, the plurality of spoiler wings being operable as being controllable by an operation controller, the operation controller being in information connection with one of the electronic control unit, the inertial measurement unit, the throttle position sensor, and the wheel speed detector and receiving one or multiple messages from the inertial measurement unit, the throttle position sensor, the wheel speed detector, or the electronic control unit to have the spoiler wings varying a pitch angle to match with a traveling condition of the motorcycle.

2. The variable spoiler wing of the motorcycle according to claim 1, wherein the motorcycle comprises a spoiler wing control system; and the operation controller is controllable for operation by the spoiler wing control system.

3. The variable spoiler wing of the motorcycle according to claim 2, wherein a control flow of the spoiler wing control system comprises a step of system starting up, a step of mode selection, an anti-wheelie function mode, a step of spoiler wing intervening threshold setting, a step of operator's intention detection, a step of throttle position detection, a step of vehicle posture detection, a step of wheel speed detection, a step of if vehicle front wheelie amount exceeding set threshold, a step of operation controller driving step motor, a step of if spoiler wing reaching down pressing force set position, a step of if vehicle front wheelie rate lowering, and a step of if spoiler wing reaching low wind resistance set position.

4. The variable spoiler wing of the motorcycle according to claim 3, wherein in the step of mode selection, a control knob arranged on the dashboard device is selected for adjusting the pitch angle of the spoiler wings.

5. The variable spoiler wing of the motorcycle according to claim 3, wherein a message of the operator's intention detection is from the electronic control unit.

6. The variable spoiler wing of the motorcycle according to claim 3, wherein a message of the throttle position detection is from the throttle position sensor.

7. The variable spoiler wing of the motorcycle according to claim 3, wherein a message of the vehicle posture detection is from the inertial measurement unit.

8. The variable spoiler wing of the motorcycle according to claim 3, wherein a message of the wheel speed detection is from the wheel speed detector.

9. The variable spoiler wing of the motorcycle according to claim 1, wherein the spoiler wings comprise a wing body, a connection rod connected to the wing bod, the connection rod being connected to the operation controller.

10. The variable spoiler wing of the motorcycle according to claim 9, wherein the wing body comprises a front end portion and a rear end portion, the front end portion being mounted with a direction indicator light indicating a traveling direction or a position light indicating a position.
